(19) United States
(12) Patent Application Publication
(10) Pub. No.: US 2006/0103841 A1
(43) Pub. Date: May 18, 2006

(54) Optical spectrum analyzer

(75) Inventors: Kazushi Ohishi, Tokyo (JP); Hiroshi Ohta, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 11/211,619

(22) Filed: Aug. 26, 2005

(30) Foreign Application Priority Data
Nov. 12, 2004 (JP) 2004-328474

(51) Int. Cl. G01J 3/28

(52) U.S. Cl. 356/328

(57) ABSTRACT

An object of the invention is to realize an optical spectrum analyzer capable of performing high-speed waveform sweep. The invention is to make improvements to an optical spectrum analyzer for measuring a spectrum of light to be measured by collimating light to be measured by collimator means, spectroscopically separating the collimated light incident from the collimator means according to an incident angle by a diffraction grating, and detecting the light spectroscopically separated by the diffraction grating by a photodetector via a slit. The device is characterized by including an acoustooptic deflector provided between the collimator means and the diffraction grating for deflecting the collimated light to be measured and changing the incident angle on the diffraction grating.

### BACKGROUND OF THE INVENTION

1. Field of the Invention

The present invention relates to an optical spectrum analyzer for measuring a spectrum of light to be measured by collimating light to be measured by collimator means, spectroscopically separating the collimated light incident from the collimator means according to an incident angle by a diffraction grating, and detecting the light spectroscopically separated by the diffracting grating by a photodetector via a slit, and specifically, to an optical spectrum analyzer capable of performing high-speed waveform sweep.

2. Description of the Related Art

FIG. 1 shows a configuration of a conventional optical spectrum analyzer and an example using a spectroscope of Czerny-Turner type as an example (e.g., see Japanese Patent Publications Nos. 3254932 and 2892670). In FIG. 1, light to be measured containing various wavelengths enters from an incident slit 1, collides with a concave mirror 2, and then turns into collimated light and enters a diffraction grating 3.

Then, when the light to be measured is incident on the diffraction grating 3 as a kind of wavelength dispersion element, it is spectroscopically separated by the diffraction grating 3. Accordingly, since the exit light from the diffraction grating 3 is propagated in different directions with respect to each wavelength, it has spatial broadening and enters a concave mirror 4. Further, the light to be measured reflected by the concave mirror 4 is condensed in different positions on a surface of an exit slit 5 with respect to each wavelength.

For example, the lights to be measured having wavelengths λ1 to λ3, respectively, are condensed in positions “P1” to “P3” of the exit slit 5. Accordingly, only the light to be measured having a wavelength component within a range of horizontal width of the exit slit 5 (e.g., the wavelength λ2 in the position P2) of the condensed lights passes through the exit slit 5 and is received by a photodetector 6. Then, the photodetector 6 outputs an electric signal depending on the light intensity of the passing light.

Here, by rotating the diffraction grating 3 by a motor (not shown), the incident angle of the light to be measured incident on the diffraction grating 3 changes, and the positions where the lights to be measured having wavelengths λ1 to λ3 are condensed on the surface of the exit slit 5 also change. By the way, many grooves are formed in the surface of the diffraction grating 3 and the rotation of the diffraction grating 3 is rotated around an axis parallel to the grooves. As a result, the wavelength passing through the exit slit 5 changes and wavelength sweep is performed. Then, a signal processing unit (not shown) obtains a characteristic of wavelength and light intensity, i.e., an optical spectrum from an electric signal output from the photodetector 6.

Such an optical spectrum analyzer is used for a wavelength monitor in optical communication of optical network, for example. Further, in the next generation optical network, data is relayed remaining as optical signals without converting the optical signals into electric signals. A technology called “burst switching” for transferring data by rapidly switching paths depending on wavelengths is used for such an optical network. Time required for high-speed path switching in the burst switching is on the order of 1 [msec], and an optical spectrum analyzer capable of accommodating the high-speed wavelength switching is needed.

However, in the optical spectrum analyzer shown in FIG. 1, there is a problem that the wavelength sweep speed is slow because the wavelength sweep is performed by rotating the diffraction grating 3 and the wavelength sweep speed depends on the speed of the motor used for rotation of the diffraction grating 3. Normally, for example, the sweep time when the wavelength sweep on the order of 1000 [nm] is performed is on the order of 1 [sec] under present circumstances, and there is a problem that real time measurement (about 1 [msec] or less) can not be performed.

### SUMMARY OF THE INVENTION

An object of the invention is to realize an optical spectrum analyzer capable of performing high-rate waveform sweep.

### BRIEF DESCRIPTION OF THE DRAWINGS

FIG. 1 shows a configuration of a conventional optical spectrum analyzer.

FIG. 2 is a configuration diagram showing the first embodiment of the invention.

FIG. 3 is a configuration diagram showing the second embodiment of the invention.

FIG. 4A shows an optical path from an AOD 9 to a diffraction grating 3 of the device shown in FIG. 2.

FIG. 4B shows an optical path from an AOD 9 to a diffraction grating 3 of the device shown in FIG. 3.

FIG. 5 is a configuration diagram showing the third embodiment of the invention.

FIG. 6 is a configuration diagram showing the fourth embodiment of the invention.

FIG. 7 is a configuration diagram showing the fifth embodiment of the invention.

### DETAILED DESCRIPTION OF THE PREFERRED EMBODIMENTS:

Hereinafter, embodiments of the invention will be described using the drawings.

### First Embodiment

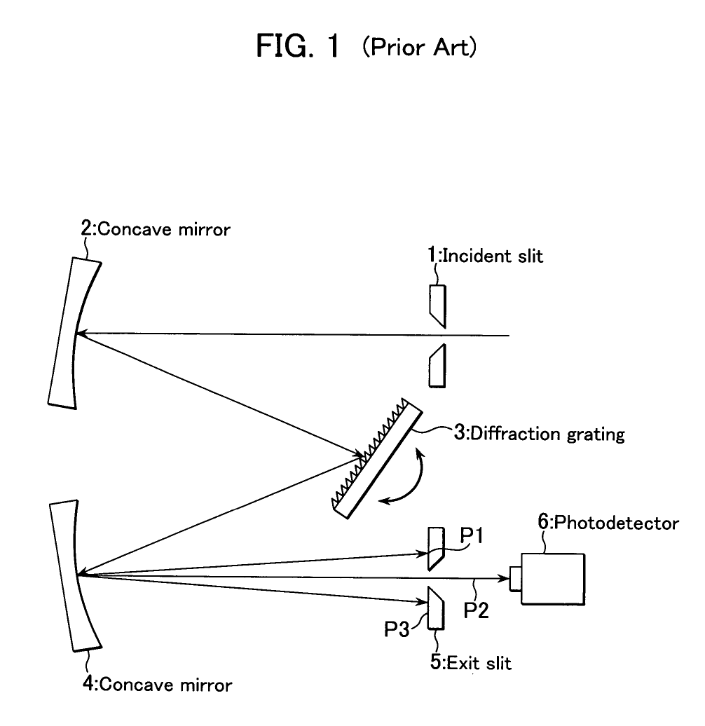

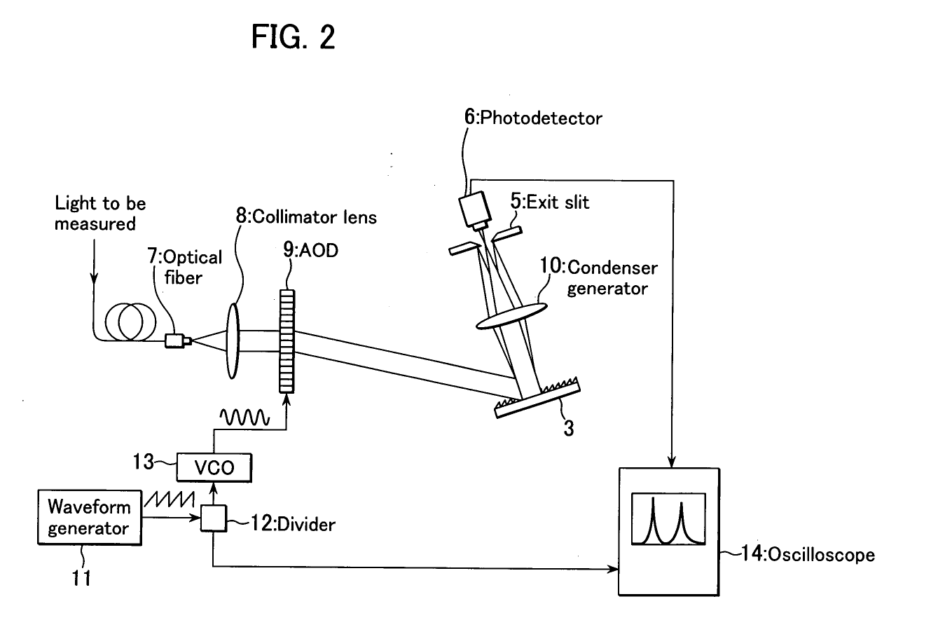

FIG. 2 is a configuration diagram showing the first embodiment of the invention. Here, the same signs are assigned to the same elements as those in FIG. 1 and the description thereof will be omitted. In FIG. 2, an optical fiber 7 is provided in place of the incident slit 1 for propagating and outputting light to be measured. A collimator lens 8 is collimator means and provided in place of the concave mirror 2 for collimating and outputting the light to be measured from the optical fiber 7.

An acoustooptic deflector (hereinafter, abbreviated as “AOD”) 9 is newly provided between the collimator lens 8 and the diffraction grating 3 for deflecting the collimated light to be measured from the collimator lens 8 and changing the incident angle of the light to be measured incident on the diffraction grating 3 from the AOD 9.

A condenser lens 10 is provided in place of the concave mirror 4 for condensing the light to be measured spectroscopically separated by the diffraction grating 3 onto the exit slit 5.

A waveform generator 11 generates ramp wave. A divider 12 divides an electric signal from the waveform generator 11 and frequency divides it according to need. A voltage controlled oscillator (hereinafter abbreviated as “VCO”) 13 outputs a high-frequency signal following the voltage of the ramp wave from the divider 12 to the AOD 9. An oscilloscope 14, with the ramp wave from the divider 12 as a trigger signal, obtains and displays an optical spectrum of the light to be measured from the data from the photodetector 6.

The operation of such a device will be described.

The light to be measured is propagated by the optical fiber 7 and output from the fiber end surface of the optical fiber 7 to the collimator lens 8 at a predetermined exit angle. Then, the collimator lens 8 collimates and outputs the light to be measured to the AOD 9.

On the other hand, in the AOD 9, compressional wave in response to the high frequency signal from the VCO 13 is generated within the AO crystal. Accordingly, the AOD 9 changes the exit direction in response to the high frequency signal, that is, deflects the collimated light to be measured and outputs the collimated light incident from the collimator lens 8 to the diffraction grating 3.

Then, the diffraction grating 3 spectroscopically separates the light to be measured incident from the AOD 9. Accordingly, since the exit light from the diffraction grating 3 is propagated in different directions with respect to each wavelength, it has spatial broadening and enters the condenser lens 10. Further, the condenser lens 10 condenses the light to be measured in different positions on the surface of the exit slit 5 with respect to each wavelength. Then, only the light to be measured having a wavelength component within a range of horizontal width of the exit slit 5 (width along the wavelength dispersion direction) of the condensed lights passes through the exit slit 5 and is received by the photodetector 6. Then, the photodetector 6 outputs an electric signal depending on the light intensity of the passing light to the oscilloscope 14.

Subsequently, the wavelength sweep operation will be described.

The divider 12 divides the ramp wave from the waveform generator 11, and outputs one to the VCO 13 and the other to the oscilloscope 14. Then, the VCO 13 outputs the high-frequency signal following the voltage of the ramp wave to the AOD 9.

Further, the compressional wave in response to the high frequency signal is generated within the AO crystal of the AOD 9, the propagation direction of the primary light generated by the AOD 9 changes. Accordingly, the incident angle of the primary light incident on the diffraction grating 3 rapidly changes. That is, the operation is the same as that for changing the incident angle on the diffraction grating 3 by rotating the diffraction grating 3 as shown in FIG. 1. As a result, the wavelength cut out by the exit slit 5 is also swept at a high speed.

Then, a signal processing unit (not shown) provided to the oscilloscope 14 obtains a characteristic of wavelength and light intensity, i.e., an optical spectrum from an electric signal output from the photodetector 6 with the electric signal from the divider 12 as a trigger signal and displays the optical spectrum.

Thus, since the AOD 9 changes the incident angle of the light to be measured incident on the diffraction grating 3, the wavelength sweep can be performed at a higher speed than that by the mechanical rotation of the diffraction grating 3 as shown in FIG. 1. For example, the AOD 9 could sweep one sweep for about 100 [μsec], and the sweep can be performed for about 1/10000 times as much as that by the device shown in FIG. 1.

Further, since the AOD 9 deflects the light to be measured, the deflection angle can be taken larger compared to that for deflecting the light to be measured using electro-optic effect. Thereby, the wavelength range for wavelength sweep can be made broader.

### Second embodiment

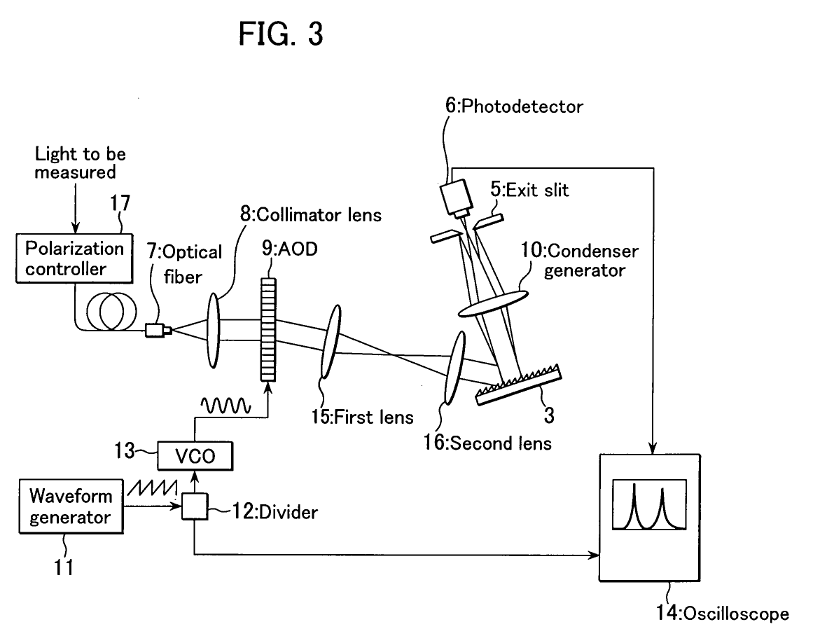

FIG. 3 is a configuration diagram showing the second embodiment of the invention. Here, the same signs are assigned to the same elements as those in FIG. 2 and the description thereof will be omitted. In FIG. 3, a first lens 15 and a second lens 16 are newly provided between the AOD 9 and the diffraction grating 3. The lenses 15 and 16 are position correction means for applying the light to be measured from the AOD 9 to the same position of the diffraction grating 3 independently of the amount of deflection of the AOD 9.

Further, the first lens 15 condenses the collimated light from the AOD 9. The second lens 16 has the same focal length f as that the first lens 15 has, is provided in a confocal position where focal positions of both coincide with each other, and collimates and outputs the light to be measured from the first lens 15 to the diffraction grating 3. That is, all of the distance from the AOD 9 to the lens 15, the distance from the lens 15 to the condensing position, and the distance from the condensing position to the lens 16, and the distance from the lens 16 to the diffraction grating 3 are the same as the focal length f.

Furthermore, a polarization controller 17 for changing the polarized wave (also referred to as “polarized light”) state of the light to be measured propagated by the optical fiber 7 into a desired state is newly provided. This polarization controller 17 is polarization control means.

The operation of the device is nearly the same as the operation of the device shown in FIG. 2, however, in a different operation, the polarization controller 17 makes the polarized wave state of the light to be measured into a desired state, for example, into a polarized wave state in which the diffraction efficiency of the diffraction grating 3 becomes the best.

Further, the lenses 15 and 16 provided in the confocal position apply the light to be measured from the AOD 9 to the predetermined position of the diffraction grating 3 independently of the amount of deflection.

Thus, since the polarization controller 17 makes the polarized wave state of the light to be measured into the polarization plane where the diffraction efficiency of the diffraction grating 3 is the best, the optical power detected by the photodetector 6 becomes larger and the measurement of optical spectrum can be performed with accuracy.

Further, the AOD 9 also has polarization dependence, and, as the polarization state changes, the exit angle of the primary light also changes. However, since the polarization controller 17 makes the polarized wave state of the light to be measured into the polarization plane and the exit angle never varies depending on the polarization state, the measurement of optical spectrum can be performed with accuracy.

Furthermore, since the lenses 15 and 16 apply the primary from the AOD 9 to the same position of the diffraction grating 3 independently of the amount of deflection of the AOD 9, the measurement of optical spectrum can be performed with accuracy as described by the following (1) to (3).

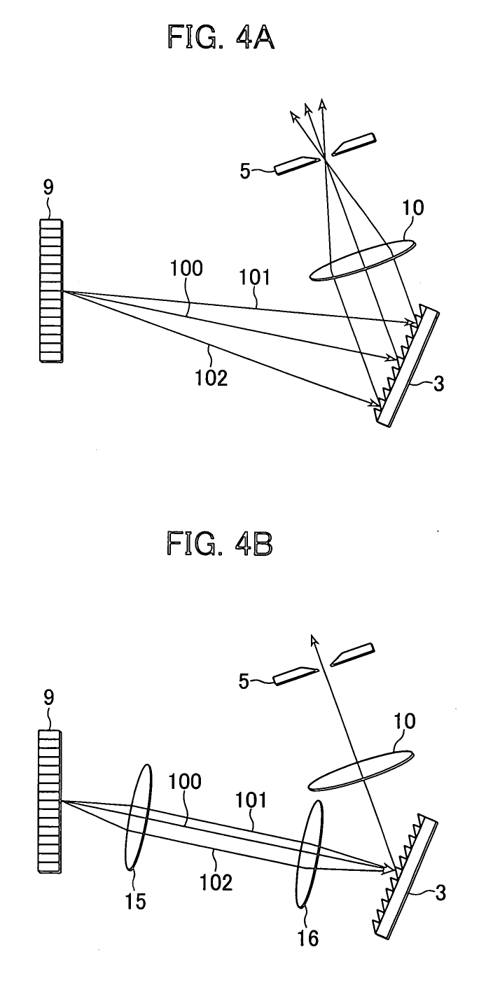

(1) FIGS. 4A and 4B will be used for description. Here, the same signs are assigned to the same elements as those in FIGS. 2 and 3 and the description thereof will be omitted. Further, the illustration other than the diffraction grating 3, the exit slit 5, the AOD 9, and the lenses 10, 15, and 16 will be omitted. FIG. 4A shows the case where the amount of deflection of the light to be measured by the AOD 9 is changed in the device shown in FIG. 2, and FIG. 4B shows the case where the amount of deflection of the light to be measured by the AOD 9 is changed in the device shown in FIG. 3. Note that only the optical axis passing through the exit slit 5 is shown and the lights to be measured 100 to 102 are respectively different in amounts of deflection.

As shown in FIG. 4A, without the lens 15 or 16, depending on the amount of deflection of the AOD 9, the positions in which the lights to be measured 100 to 102 are applied to the diffraction grating 3 are different. Accordingly, even when the lights to be measured 100 to 102 have wavelength components passing through the exit slit 5, the positions where they enter the condenser lens 10 are different.

On the other hand, as shown in FIG. 4B, with the lenses 15 and 16, independent of the amount of deflection of the AOD 9, the positions in which the lights to be measured 100 to 102 are applied to the diffraction grating 3 become the same. Accordingly, the positions where they enter the condenser lens 10 also become the same.

Thus, since the lenses 15 and 16 apply the primary light from the AOD 9 to the same position of the diffraction grating 3 independently of the amount of deflection of the AOD 9, the light is transmitted through the same position of the condenser lens 10 and condensed on the slit 5. That is, aberration such as spherical aberration and chromatic aberration exists in the lens 10, however, since the lights to be measured 100 to 102 pass through the same position of the lens 10 independently of the amount of deflection, the influence of aberration can be reduced. Thereby, the condensed beam diameter at the slit 5 changes little. Therefore, the wavelength resolution never changes depending on wavelengths, the wavelength dependency of the wavelength resolution can be reduced, and the measurement of optical spectrum can be performed with accuracy.

(2) In the device shown in FIG. 2, since the positions where the light is applied to the diffraction grating 3 are different depending on the amounts of deflection, there is no linearity in the relationship between the amount of deflection at the AOD 9 and the wavelength passing through the slit 5. On the other hand, in the device shown in FIG. 3, the lenses 15 and 16 apply the primary light from the AOD 9 to the same position of the diffraction grating 3 independently of the amount of deflection of the AOD 9, if the condenser lens 10 and the diffracting plane of the diffraction grating 3 are in parallel, there is linearity in the relationship between the amount of deflection at the AOD 9 and the wavelength passing through the slit 5. Therefore, the optical spectrum becomes easier to be obtained by the signal processing unit (not shown) and the measurement of optical spectrum can be performed with accuracy.

(3) The angle at which the AOD 9 can deflect the primary light is normally on the order of 2 to 3°, and 5° at the maximum. Recently, the wavelength bands often used in optical communication are S-band (1460 to 1530 [nm]), C-band (1530 to 1565 [nm]), and L-band (1565 to 1625 [nm]), however, there is a problem that it is difficult to wavelength sweep all of these wavelength ranges. Accordingly, the diffraction grating 3 may be rotated with respect to each band. For example, the diffraction grating 3 is rotated around an axis parallel to the grooves of the diffraction grating 3 in the same manner as in the device shown in FIG. 1.

Specifically, wavelength sweep of the S-band is performed by the AOD 9. Then, the diffraction grating 3 is rotated to an optimum angle for measuring the C-band, and, after the rotation of the diffraction grating 3 is ended, the wavelength sweep of the C-band is performed by the AOD 9. Furthermore, the diffraction grating 3 is rotated to an optimum angle for measuring the L-band, and, after the rotation of the diffraction grating 3 is ended, the wavelength sweep of the L-band is performed by the AOD 9.

At this time, in the device shown in FIG. 2, the position where the diffraction grating 3 is applied with light differs depending on the amount of deflection. Accordingly, when the diffraction grating 3 is rotated, the position where the light enters the diffraction grating 3 becomes different even if the amount of deflection of the AOD 9 is the same. On this account, there has been a problem that the adjustment of an optical system becomes very difficult. On the other hand, in the device as shown in FIG. 3, since the lenses 15 and 16 apply the primary light from the AOD 9 to the same position of the diffraction grating 3 independently of the amount of deflection of the AOD 9, if the center of the rotation axis of the diffraction grating 3 matches the center of the beam applied to the diffraction grating 3, the beam is applied to the same position regardless of the rotation angle of the diffraction grating 3. Thereby, the adjustment of the optical system becomes easy and the measurement of optical spectrum can be performed with accuracy.

### Third Embodiment

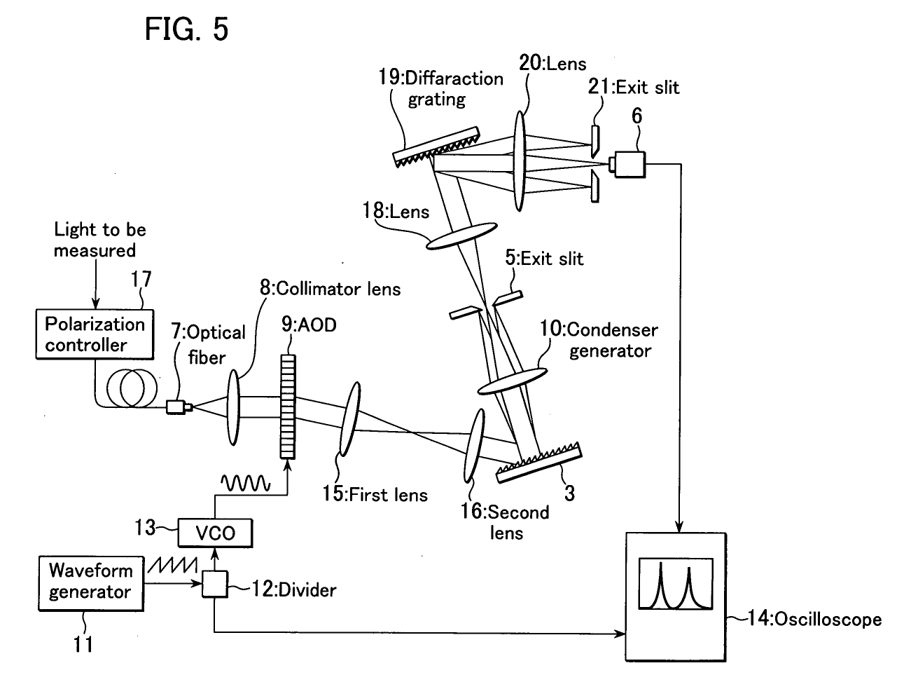

FIG. 5 is a configuration diagram showing the third embodiment of the invention, and an example in which the invention is applied to additional dispersion. Here, the same signs are assigned to the same elements as those in FIG. 3 and the description and the illustration thereof will be omitted. In FIG. 5, the light to be measured that has passed through the exit slit 5 is collimated by a lens 18 and enters a second diffraction grating 19.

Then, when the light to be measured enters the diffraction grating 19, it is spectroscopically separated by the diffraction grating 19. That is, the device has a double-pass structure in which spectroscopic separation is performed twice by the diffraction gratings 3 and 19. By the way, if the focal lengths of the lenses 10 and 18 are the same, the respective diffracting planes of the diffraction gratings 3 and 19 are in one-to-one image formation relationship. Regardless to add, the exit slit 5 is disposed at a Fourier plane located intermediate between the lenses 10 and 18.

Further, in the diffraction by the diffraction gratings 3 and 19, because the refraction angle becomes larger at the short-wavelength side than at the long-wavelength side, the spectroscopic angle becomes larger by providing the diffraction grating 19 as shown in FIG. 5. That is a so-called additional dispersion. Note that the slit 5 is used for removing stray light and does not contribute to the wavelength resolution.

The exit light from the diffraction grating 19 has spatial broadening because it is propagated in different directions with respect to each wavelength, and condensed in different positions on a surface of an exit slit 21 with respect to each wavelength by a lens 20. Then, only light having a desired wavelength component is cut out by the exit slit 21 and received by the photodetector 6. Since the wavelength sweep etc. and other operations are the same as those in the device shown in FIG. 3, the description thereof will be omitted.

Thus, since the diffraction grating 19 additionally dispersed spectroscopically separates the light to be measured that has been spectroscopically separated by the diffraction grating 3 again, the spectroscopic angle becomes larger and the wavelength resolution is improved. For example, if one equal to the diffraction grating 3 is used as the diffraction grating 19, the wavelength resolution improved to be twice. Thereby, the measurement of optical spectrum of the light to be measured can be performed with accuracy.

### Fourth Embodiment

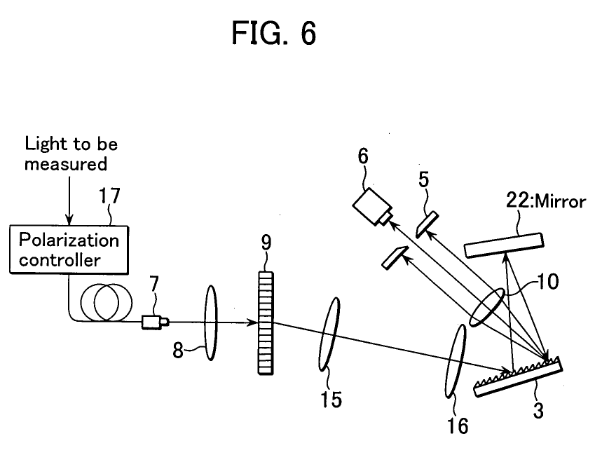

FIG. 6 is a configuration diagram showing the fourth embodiment of the invention, and an example in which the invention is applied to additional dispersion different from that in FIG. 5. Here, the same signs are assigned to the same elements as those in FIG. 3 and the description thereof will be omitted. Further, the illustration of the waveform generator 11, the divider 12, the VCO 13, and the oscilloscope 14 will be omitted and only the optical axis is shown.

In FIG. 6, a mirror 22 newly provided reflects the light spectroscopically separated by the diffraction grating 3 and allows the light to enter the diffraction grating 3 again. Then, the diffraction grating 3 spectroscopically separates the reflected light from the mirror 22 again, and the condenser lens 10 condenses the spectroscopically re-separated light on the exit slit 5. Since other operations are the same as those in the device shown in FIG. 3, the description thereof will be omitted.

Thus, the mirror 22 allows the light spectroscopically separated by the diffraction grating 3 to enter the diffraction grating 3 again and the diffraction grating 3 spectroscopically separates the light again. That is, since the additional dispersion has a double-pass structure, the spectroscopic angle becomes larger and the wavelength resolution improved. Thereby, the measurement of optical spectrum of the light to be measured can be performed with accuracy by the smaller number of diffraction grating than in the device shown in FIG. 5.

### Fifth Embodiment

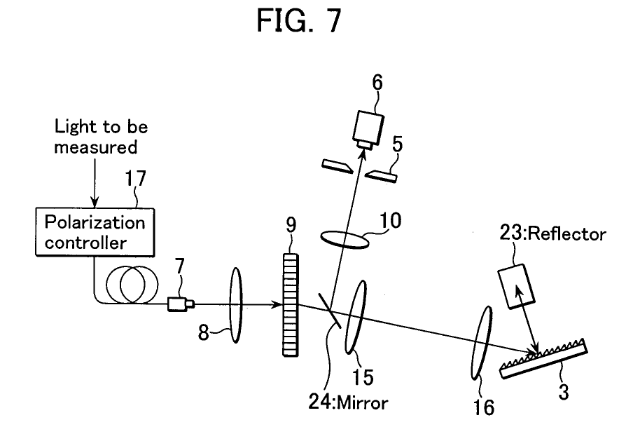

FIG. 7 is a configuration diagram showing the fifth embodiment of the invention, and an example in which the invention is applied to additional dispersion different from those in FIGS. 5 and 6. Here, the same signs are assigned to the same elements as those in FIG. 3 and the description thereof will be omitted. Further, the illustration of the waveform generator 11, the divider 12, the VCO 13, and the oscilloscope 14 will be omitted and only the optical axis is shown.

In FIG. 7, a corner cube reflector 23 newly provided reflects the light spectroscopically separated by the diffraction grating 3 and allows the light to enter the diffraction grating 3 again. Note that the reflector 23 reflects the light while shifting the optical axis in parallel only in the direction along the grooves of the diffraction grating 3. Then, the diffraction grating 3 spectroscopically separates the reflected light from the reflector 23 again.

Furthermore, the spectroscopically re-separated light is propagated by the lenses 16 and 15, and reflected in return to the condenser lens 10 by a mirror 24 newly provided. Note that, since the optical axis of the light from the AOD 9 to the lens 15 is shifted in the direction along the grooves from the optical axis of the return light that has returned from the diffraction grating 3 through the lenses 16 and 15, the mirror 24 reflects only the return light to the condenser lens 10. Then, the condenser lens 10 condenses the light from the mirror 24 on the exit slit 5. Since other operations are the same as those in the device shown in FIG. 3, the description thereof will be omitted.

Thus, the reflector 23 allows the light spectroscopically separated by the diffraction grating 3 to enter the diffraction grating 3 again and the diffraction grating 3 spectroscopically separates the light again. That is, since the additional dispersion has a double-pass structure, the spectroscopic angle becomes larger and the wavelength resolution is improved. Thereby, the measurement of optical spectrum of the light to be measured can be performed with accuracy by the smaller number of diffraction grating than in the device shown in FIG. 5.

The invention is not limited to those described above, and the following configurations may be adopted.

In the devices shown in FIGS. 2, 3, 5 to 7, the configuration for transmitting the light to be measured by the optical fiber 7 has been shown, however, an incident slit is provided as shown in FIG. 1, and the light to be measured may be passed through the incident slit. Further, the configuration in which the lens 8 is provided as an example of the collimator means has been shown, however, a parabolic mirror may be used as shown in FIG. 1.

In the devices shown in FIGS. 3, 5 to 7, the configuration using the polarization controller 17 has been shown, however, a polarization scrambler for making the polarization state into a random state may be used. That is, the polarization dependence of the AOD 9 and the diffraction gratings 3 and 19 can be reduced by making the polarized state of the light to be measured into a random state sufficiently at a higher speed than the speed of wavelength sweep.

In the devices shown in FIGS. 3, 5 to 7, the configuration using the polarization controller 17 has been shown, however, a depolarization plate (e.g., see paragraph numbers 0012 to 0017, FIGS. 1, 2, and 8 of Japanese Patent Publication No. 2995985) may be provided in the precedent stage of the AOD 9, for example, between the lens 8 and the AOD 9. Further, since the depolarization plate makes the polarized wave state of the light to be measured into a state in which many polarized wave states are spatially mixed, i.e., a random state, the polarization dependence of the AOD 9 and the diffraction gratings 3 and 19 can be reduced.

By the way, the depolarization plate is formed by bonding a first crystal plate having a thickness continuously changing in a direction at 45° to a first optical axis and a second crystal plate having a thickness continuously changing in a direction at 45° to a second optical axis with the first optical axis and the second optical axis set mutually perpendicular.

In the devices shown in FIGS. 3, 5 to 7, the configuration in which both the polarization controller and the position correction means are provided has been shown, however, only one of them may be provided.

In the devices shown in FIGS. 5 to 7, the configuration having the double-pass structure in which the light is spectroscopically separated twice by the diffraction gratings 3 and 19 has been shown, however, no matter how many times the spectroscopic separation may be performed and a multi-pass structure may be adopted. Further, differential dispersion may be adopted in place of the additional dispersion.

According to the invention, the effects as below can be obtained.

Since the acoustooptic deflector changes the incident angle of the light to be measured incident on the diffraction grating, the wavelength sweep can be performed at a higher speed than wavelength sweep by the mechanical rotation of the diffraction grating.

Since the position correction means apply the primary light from the acoustooptic deflector to the same position of the diffraction grating independently of the amount of deflection of the acoustooptic deflector, the measurement of optical spectrum can be performed with accuracy.

Since the polarization control means makes the light to be measured into a desired polarization state, the polarization dependence of the acoustooptic deflector and the diffraction grating can be reduced.

What is claimed is:

1. An optical spectrum analyzer for measuring a spectrum of light to be measured by collimating light to be measured by collimator means, spectroscopically separating the collimated light incident from the collimator means according to an incident angle by a diffraction grating, and detecting the light spectroscopically separated by the diffraction grating by a photodetector via a slit,
the optical spectrum analyzer comprising an acoustooptic deflector provided between the collimator means and the diffraction grating for deflecting the collimated light to be measured and changing the incident angle on the diffraction grating.

2. An optical spectrum analyzer according to claim 1, further comprising position correction means provided between the acoustooptic deflector and the diffraction grating for applying the light to be measured from the acoustooptic deflector to the same position of the diffraction grating independently of an amount of deflection.

3. An optical spectrum analyzer according to claim 2, wherein the position correction means includes:
a first lens for condensing the light to be measured from the acoustooptic deflector; and
a second lens having the same focal length as that the first lens has, provided in a confocal position where focal positions of both coincide with each other, and collimating and outputting the light to be measured from the first lens to the diffraction grating.

4. An optical spectrum analyzer according to any one of claims 1 to 3, further comprising polarization control means for making the polarized wave state of the light to be measured into a desired state and outputting the light to the acoustooptic deflector.

5. An optical spectrum analyzer according to claim 4, wherein the polarization control means is a polarization scrambler.

6. An optical spectrum analyzer according to claim 4, wherein the polarization control means is a polarization controller.

7. An optical spectrum analyzer according to claim 4, wherein the polarization control means is a depolarization plate.
